(19) United States
(12) Patent Application Publication
(10) Pub. No.: US 2024/0001702 A1
(43) Pub. Date: Jan. 4, 2024

(54) METHOD FOR MANUFACTURING RECORDED MATTER HAVING STEREOSCOPIC IMAGE AND MANUFACTURING APPARATUS OF RECORDED MATTER HAVING STEREOSCOPIC IMAGE

(71) Applicant: CANON KABUSHIKI KAISHA, Tokyo (JP)

(72) Inventors: TOSHIHIRO OMAGARI, Kanagawa (JP); OLIVIA HERLAMBANG, Kanagawa (JP); TAKATOSHI TANAKA, Tokyo (JP); YOSHIYUKI NAGASE, Kanagawa (JP); TETSURO NOGUCHI, Tokyo (JP)

(21) Appl. No.: 18/344,630

(22) Filed: Jun. 29, 2023

(30) Foreign Application Priority Data
Jul. 1, 2022 (JP) 2022-107061
Jun. 8, 2023 (JP) 2023-094576

(51) Int. Cl. B41M 3/06; B29C 44/34; B32B 27/30

(52) U.S. Cl. CPC B41M 3/06; B29C 44/3415; B29C 44/355; B32B 27/308; B29C 44/353

(57) ABSTRACT

A method for manufacturing a recorded matter having a stereoscopic image includes a first heating step, a foaming control liquid application step, and a second heating step. A surface temperature T0 (° C.) of the record medium before being heated in the first heating step, a surface temperature T1 (° C.) of the record medium after being heated in the first heating step, and a foaming start temperature Tf (° C.) of the foaming material satisfy a relationship represented by Formula (1):

T0<T<Tf (1).

### BACKGROUND OF THE INVENTION

### Field of the Invention

The present disclosure relates to a method for manufacturing a recorded matter having a stereoscopic image and a manufacturing apparatus of a recorded matter having a stereoscopic image.

### Description of the Related Art

In recent years, stereoscopic image forming apparatuses having a function of heating and foaming a record medium containing a foaming material to form a stereoscopic image have been developed. Japanese Patent Laid-Open No. 2022-80886 discloses that a recorded matter having a stereoscopic image is obtained by applying a foaming promotion liquid containing a foaming promotion component for decreasing a foaming start temperature of a foaming particle to a record medium including a foaming layer containing the foaming particle and, thereafter, performing heating. In addition, to increase the speed of stereoscopic image formation, research on decreasing a foaming time has been performed. For example, Japanese Patent Laid-Open No. 2020-138488 proposes a foaming apparatus including a first heater for heating a foamable medium serving as a record medium at a first temperature lower than the foaming temperature and a second heater for foaming the record medium heated with the first heater by performing heating at a second temperature higher than or equal to the foaming temperature to produce a recorded matter having a predetermined stereoscopic image at a low temperature and a high speed. Further, Japanese Patent Laid-Open No. 2020-138488 discloses that a foaming promotion layer may be formed on the foaming layer of the record medium in advance in accordance with the predetermined design flexibility.

### SUMMARY OF THE INVENTION

The present disclosure provides a method for manufacturing a recorded matter having a stereoscopic image, the method being capable of forming a stereoscopic image, in which the foamability of a foaming material is controlled and which has a sufficient foaming height, even when a recorded matter having a stereoscopic image is produced at a high speed and provides a manufacturing apparatus of a recorded matter having a stereoscopic image.

An aspect according to the present disclosure provides a method for manufacturing a recorded matter having a stereoscopic image, the method including a first heating step of heating a record medium including a substrate and a foaming layer that is disposed on the substrate and that contains a foaming material to be foamed due to heat and a binder resin, a foaming control liquid application step of applying a foaming control liquid for controlling foaming of the foaming material to the surface of the record medium heated in the first heating step by an ink jet recording head, and a second heating step of heating the record medium provided with the foaming control liquid to form a stereoscopic image, wherein a surface temperature T0 (° C.) of the record medium before being heated in the first heating step, a surface temperature T1 (° C.) of the record medium after being heated in the first heating step, and a foaming start temperature Tf (° C.) of the foaming material satisfy a relationship represented by Formula (1):

T0<T1<Tf (1).

Another aspect according to the present disclosure provides a manufacturing apparatus of a recorded matter having a stereoscopic image, the manufacturing apparatus including a first heating unit configured to heat a record medium including a substrate and a foaming layer that is disposed on the substrate and that contains a foaming material to be foamed due to heat and a binder resin, a foaming control liquid application unit configured to apply a foaming control liquid for controlling foaming of the foaming material to the surface of the record medium heated by the first heating unit, by an ink jet recording head, and a second heating unit configured to heat the record medium provided with the foaming control liquid to form a stereoscopic image, wherein a surface temperature T0 (° C.) of the record medium before being heated by the first heating unit, a surface temperature T1 (° C.) of the record medium after being heated by the first heating unit, and a foaming start temperature Tf (° C.) of the foaming material satisfy a relationship represented by Formula (1):

T0<T1<Tf (1).

Further features of the present disclosure will become apparent from the following description of exemplary embodiments with reference to the attached drawings.

### BRIEF DESCRIPTION OF THE DRAWINGS

FIG. 1 is a schematic sectional view illustrating an example of a record medium used in a method for manufacturing a recorded matter having a stereoscopic image.

FIG. 2 is a schematic diagram illustrating the configuration of a manufacturing apparatus of a recorded matter having a stereoscopic image.

FIGS. 3A to 3C are diagrams illustrating specific examples of the order of arrangement of a foaming control liquid application unit, a heating unit, and an ink application unit in a manufacturing apparatus of a recorded matter having a stereoscopic image.

### DESCRIPTION OF THE EMBODIMENTS

According to the research by the present inventors, it was found that the method for manufacturing a recorded matter having a stereoscopic image described in Japanese Patent Laid-Open No. 2022-80886 has to be further improved to form a stereoscopic image having a sufficient foaming height while a conveyance speed of the record medium is increased. In addition, when a record medium in which a foaming promotion layer is formed on a foaming layer in advance is used, as described in Japanese Patent Laid-Open No. 2020-138488, it is possible to form only a predetermined stereoscopic image, and it is unable to appropriately change the shape of the stereoscopic image in accordance with the demand of the user. In this regard, provided that a foaming promotion layer is formed from a foaming promotion liquid containing a foaming promotion agent and a solvent, it is possible to change the shape of the stereoscopic image in accordance with the demand of the user by changing the position of application of the foaming promotion liquid. However, the solvent in the foaming promotion liquid is evaporated due to heating by the first heater. As a result, the viscosity of the foaming promotion liquid is readily increased, and the concentration of the foaming promotion agent in the foaming promotion liquid is readily increased. When the viscosity of the foaming promotion liquid is increased, the foaming promotion agent contained in the foaming promotion liquid does not readily permeate the foaming layer, and foaming of the foaming layer is not readily promoted due to the foaming promotion agent. In addition, when the concentration of the foaming promotion agent is increased, the foaming layer is excessively foamed. As described above, when the foaming promotion layer is formed in advance on the foaming layer before preheating which is performed before the foaming layer of the record medium is foamed, control of the foamability of the foaming layer may become difficult. Therefore, the present inventors performed intensive research on a method for manufacturing a recorded matter having a stereoscopic image, the method being capable of forming a stereoscopic image, in which the foamability of a foaming material is controlled and which has a sufficient foaming height, even when a recorded matter having a stereoscopic image is produced at a high speed and a manufacturing apparatus of a recorded matter having a stereoscopic image, and the present disclosure was realized.

The present disclosure will be described below in further detail with reference to the preferred embodiment. Hereafter, an ink jet aqueous ink may be referred to simply as “ink”. The foaming control liquid for forming the stereoscopic image may be referred to simply as “foaming control liquid”. The method for manufacturing a recorded matter having a stereoscopic image may be referred to simply as “method for manufacturing a recorded matter”, and the manufacturing apparatus of a recorded matter having a stereoscopic image may be referred to simply as “manufacturing apparatus of a recorded matter”. The physical property value is a value at normal temperature (25° C.), unless otherwise specified.

### Method for Manufacturing Recorded Matter Having Stereoscopic Image

A method for manufacturing a recorded matter according to the present disclosure includes a first heating step of heating a record medium including a substrate and a foaming layer that is disposed on the substrate and that contains a foaming material to be foamed due to heat and a binder resin, a foaming control liquid application step of applying a foaming control liquid for controlling foaming of the foaming material to the surface of the record medium heated in the first heating step by an ink jet recording head, and a second heating step of heating the record medium provided with the foaming control liquid to form a stereoscopic image.

In this regard, a surface temperature T0 (° C.) of the record medium before being heated in the first heating step, a surface temperature T1 (° C.) of the record medium after being heated in the first heating step, and a foaming start temperature Tf (° C.) of the foaming material satisfy a relationship represented by Formula (1),

T0<T1<Tf (1).

The foaming control liquid is applied to the surface of the record medium by an ink jet recording head and permeates the foaming layer, and the foaming start temperature of the foaming material in the foaming layer is changed. Consequently, when the record medium provided with the foaming control liquid is heated, foaming of the foaming material in the foaming layer in the region provided with the foaming control liquid is promoted or suppressed. When the foaming control liquid is a foaming promotion liquid for promoting foaming of the foaming material, since the region provided with the foaming promotion liquid in the foaming layer is made into a protruding portion higher than the region not provided with the foaming promotion liquid (that is, the thickness of the foaming layer is increased), a stereoscopic image is formed by the protruding portion. On the other hand, when the foaming control liquid is a foaming suppression liquid for suppressing the foaming material from being foamed, since the region not provided with the foaming suppression liquid in the foaming layer is made into a protruding portion higher than the region provided with the foaming suppression liquid, a stereoscopic image is formed by the protruding portion.

However, it was found from the research by the present inventors that even when the record medium provided with the foaming control liquid is heated in a range in which the surface temperature of the record medium is not higher than the foaming start temperature (Tf) of the foaming material, it is difficult to control the foamability of the foaming material due to a decrease in a foaming control component through evaporation of the foaming control component, an increase in the viscosity of the foaming control component or an increase in the concentration of the foaming control liquid resulting from the liquid in the foaming control liquid decreasing, and the like. Consequently, in the present disclosure, the record medium before being provided with the foaming control liquid is heated in advance in the first heating step so that the surface temperature becomes a temperature lower than a foaming start temperature (Tf) of the foaming material (that is, T1<Tf). Thereafter, the foaming control liquid is applied to the record medium heated in the first heating step. The surface temperature of the record medium being increased, in the first heating step, from the surface temperature T0 (° C.) of the record medium before heating to the surface temperature T1 (° C.) of the record medium after heating enables the foaming control liquid to sufficiently spread throughout the foaming layer (in particular, in the thickness direction of the foaming layer) as a result of the viscosity of the foaming control liquid being decreased when the foaming control liquid is applied to the record medium heated in the first heating step and enables a stereoscopic image having a sufficient foaming height to be formed in the second heating step thereafter. In such an instance, the temperature of the foaming control liquid is temporarily increased due to contact with the hated foaming layer. However, since the foaming control liquid is not continuously heated, in contrast to the disclosure described in Japanese Patent Laid-Open No. 2020-138488, a decrease of the liquid in the foaming control liquid due to evaporation, an increase in the viscosity of the foaming control liquid, an increase in the concentration of the foaming control component, and the like do not readily occur.

Consequently, it is possible to suppress variations in the foamability of the foaming material due to the foaming control liquid from occurring and to control the foamability. In addition, when the foaming control liquid is sufficiently spread throughout the foaming layer and, thereafter, the second heating step is performed, as described above, the liquid in the foaming control liquid is evaporated at first, and the surface temperature of the record medium is increased with a heating time. Subsequently, the foaming control liquid being the foaming promotion liquid enables the region provided with the foaming control liquid to be selectively foamed when the surface temperature of the record medium reaches the foaming start temperature of the foaming material decreased due to the foaming promotion liquid. In this regard, the foaming control liquid being the foaming suppression liquid enables the region not provided with the foaming suppression liquid to be selectively foamed when the surface temperature of the record medium reaches the foaming start temperature of the foaming material not provided with the foaming suppression liquid. As a result, a stereoscopic image in which foaming is selectively controlled and which has a sufficient foaming height is obtained.

Further, in the first heating step, heating is performed so that the surface temperature T1 of the record medium after being heated in the first heating step and the foaming start temperature Tf (° C.) of the foaming material satisfy T1<Tf. Consequently, the foaming layer in the region not provided with the foaming control liquid is suppressed from foaming.

The surface temperature T1 of the record medium can be higher than or equal to the glass transition temperature Tg of the binder resin contained in the foaming layer of the record medium. The surface temperature T1 being controlled to be within the above-described range enables a recorded matter having a stereoscopic image with a sufficient foaming height to be produced since the binder resin contained in the foaming layer of the record medium is softened before the foaming control liquid is applied to the record medium so that foaming of the foaming material is not readily hindered in the second heating step. In this regard, after the foaming control liquid is applied to the record medium, when heating is performed so that the surface temperature of the record medium is lower than the glass transition temperature Tg of the binder resin contained in the foaming layer, since most of the heat energy applied in the first heating step is consumed for evaporating the liquid contained in the foaming control liquid. Therefore, when a recorded matter having a stereoscopic image is produced at a high speed, since the surface temperature T1 of the record medium is not readily increased to a predetermined temperature, the binder resin contained in the foaming layer is not sufficiently softened, and it is difficult to obtain a stereoscopic image with sufficient foaming height.

In this regard, the surface temperature of the record medium is the temperature of a surface on the foaming layer side of the record medium.

The foaming start temperature of the foaming material acted upon by the foaming control component may be measured by a method described below. Initially, to bring the foaming material into the state of being acted upon by the foaming control component, the foaming material is dipped in the foaming control liquid for 10 sec. The foaming material serving as a sample in an amount of 25 μg after dipped in the foaming control liquid is placed into an aluminum container having a diameter of 7 mm and a depth of 1 mm. The aluminum container is attached to a thermomechanical analyzer, heating is performed from 60° C. to 200° C. at a temperature increase rate of 5° C./min while a load of 0.1 N is applied to the foaming material from above so as to measure the displacement (the displacement of the height of the portion occupied by the sample) of the measurement terminal in the vertical direction.

Subsequently, the temperature at the point in time when the displacement is started is specified to be the foaming start temperature of the foaming material acted upon by the foaming control component. In this regard, the foaming start temperature of the foaming material not acted upon by the foaming control component is a temperature described below. That is, the foaming start temperature is measured in the method akin to that of the above-described foaming material acted upon by the foaming control component except that the foaming material not acted upon by the foaming control component is used as the sample.

In the second heating step, the record medium provided with the foaming control liquid is heated to form a stereoscopic image.

The surface temperature T1 (° C.) of the record medium after being heated in the first heating step and the surface temperature T2 (° C.) of the record medium after being heated in the second heating step can satisfy the relationship represented by Formula (2),

T1<T2 (2).

T1 and T2 satisfying the relationship represented by Formula (2) above enables a stereoscopic image having a sufficient foaming height to be formed.

In this regard, when the foaming control liquid is the foaming promotion liquid, T2, Tf, and the foaming start temperature Tf of the foaming material provided with the foaming promotion liquid (the foaming material acted upon by the foaming promotion component) can satisfy the relationship represented by Formula (3),

Tf′<T2<Tf (3).

T2, Tf, and Tf′ satisfying the relationship represented by Formula (3) above enables only the foaming layer in the region provided with the foaming promotion liquid to be foamed in the second heating step and enables a clear stereoscopic image to be formed.

Further, when the foaming control liquid is the foaming promotion liquid, T0, T1, T2, Tf, and Tf′ can satisfy Formula (4),

T0<T1<Tf′<T2<Tf (4).

T0, T1, T2, Tf, and Tf′ satisfying the relationship represented by Formula (4) above enables a clearer stereoscopic image to be formed.

On the other hand, when the foaming control liquid is the foaming suppression liquid, T2, Tf, and the foaming start temperature Tf″ of the foaming material provided with the foaming suppression liquid (the foaming material acted upon by the foaming suppression component) can satisfy the relationship represented by Formula (5),

Tf<T2<Tf″ (5).

T2, Tf, and Tf″ satisfying the relationship represented by Formula (5) above enables only the foaming layer in the region not provided with the foaming suppression liquid to be foamed in the second heating step and enables a clear stereoscopic image to be formed. In this regard, when the foaming start temperature of the foaming material acted upon by the foaming suppression component is unable to be measured since the foaming material is not foamed, T2 and Tf can satisfy the relationship represented by Formula (5′),

Tf<T2 (5′).

Further, when the foaming control liquid is the foaming suppression liquid, T0, T1, T2, Tf, and Tf″ can satisfy Formula (6),

T0<T1<Tf<T2<Tf″ (6).

T0, T1, T2, Tf, and Tf″ satisfying the relationship represented by Formula (6) above enables a clearer stereoscopic image to be formed. In this regard, when the foaming start temperature of the foaming material acted upon by the foaming suppression component is unable to be measured since the foaming material is not foamed, T0, T1, T2 and Tf can satisfy the relationship represented by Formula (6′),

T0<T1<Tf<T2 (6′).

It is sufficient that the method for heating the record medium is a method in which a heating unit capable of heating the surface of the record medium to a predetermined temperature is used. In this disclosure, “the surface temperature T0 (° C.) of the record medium before being heated in the first heating step” means the surface temperature of the record medium immediately before the first heating step. “The surface temperature T1 (° C.) of the record medium after being heated in the first heating step” means the surface temperature of the record medium immediately after the first heating step. “The surface temperature T2 (° C.) of the record medium after being heated in the second heating step” means the surface temperature of the record medium immediately after the second heating step. In this regard, all the surface temperatures T0, T1, and T2 of the record medium may be measured by using a noncontact type infrared thermometer or the like.

The surface temperature T0 of the record medium before being heated in the first heating step can be room temperature. Specifically, T0 can be 25° C.

An ink containing a dye or a pigment as a coloring agent may be applied to the record medium to record (print) an optional image before or after the foaming control liquid is applied to the surface of the record medium or before or after the record medium provided with the foaming control liquid is heated.

### Record Medium

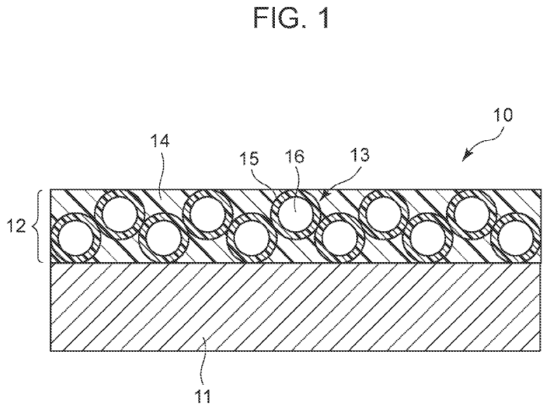

FIG. 1 is a schematic sectional view illustrating an example of a record medium used in the method for manufacturing a recorded matter having a stereoscopic image. As illustrated in FIG. 1, a record medium 10 includes a substrate 11 and a foaming layer 12 that is disposed on the substrate 11 and that contains a foaming material 13 to be foamed due to heat. The record medium used in the method for manufacturing a recorded matter according to the present disclosure will be described below in detail.

### Substrate

The substrate 11 functions as a supporting member for supporting the foaming layer 12. There is no particular limitation regarding the type of the substrate. Examples of the substrate include paper composed of common natural pulp; kenaf paper; plastic film sheets such as polypropylenes, polyethylenes, and polyesters; and so-called synthetic paper and nonwoven fabric which are synthetic fibers, synthetic pulp, or synthetic resin films made into artificial paper.

### Foaming Layer

As illustrated in FIG. 1, the foaming layer 12 is a layer that is disposed on at least one surface of the substrate 11 and that contains a foaming material such as a foaming particle 13 and a binder resin 14. A chemical foaming material or a microcapsule-type foaming material (foaming particle 13) may be used as the foaming material. Of these, the microcapsule-type foaming material can be used. The foaming particle 13 that is the microcapsule-type foaming material includes a shell layer 15 containing a thermoplastic resin and includes a volatile material 16 sealed in the shell layer 15. When heat is applied to the foaming particle 13, the thermoplastic resin constituting the shell layer 15 is softened, and, in addition, the volatile material 16 sealed in the shell layer 15 is vaporized to cause volume expansion. Consequently, the foaming particle 13 is expanded like a balloon. On the other hand, when heat is applied to the chemical foaming material, gas is generated from the chemical foaming material, a bubble is formed in the foaming layer 12 due to the resulting gas, and the foaming layer 12 is thereby expanded. As described above, the foaming layer containing the foaming material being heated enables the thickness of the foaming layer to be increased. Examples of the thermoplastic resin contained in the shell layer in the microcapsule-type foaming material include polystyrenes, styrene-acrylic acid ester copolymers, polyamide resins, polyacrylic acid esters, polyvinylidene chlorides, polyacrylonitriles, polymethyl methacrylates, vinylidene-chloride-acrylonitrile copolymers, methacrylic acid ester-acrylic acid copolymers, vinylidene chloride-acrylic acid copolymers, and vinylidene chloride-acrylic acid ester copolymers. Of these, the thermoplastic resin can be a polyacrylonitrile copolymer.

Examples of the volatile material in the microcapsule-type foaming material include low-molecular-weight hydrocarbons, such as ethane, ethylene, propane, propene, n-butane, isobutane, n-pentane, isopentane, neopentane, n-hexane, heptane, and petroleum ether; chlorofluorocarbons, such as CCl₃F, CCl₂F₂, CClF₃, and CClF₂—CClF₂; tetraalkylsilanes, such as tetramethylsilane, trimethylethylsilane, trimethylisopropylsilane, and trimethyl-n-propylsilane.

Of these, the volatile material can be isobutane. In addition, the volatile material can be a hydrocarbon having a molecular weight of 120 or less. In this regard, there is no particular limitation regarding the lower limit of the molecular weight of the volatile material (hydrocarbon), and the lower limit can be, for example, 50 or more.

The content of the foaming particle in the foaming layer can be 5% by mass or more and 95% by mass or less with reference to the total mass of the foaming layer.

Examples of the chemical foaming material include organic thermal-decomposition-type foaming agents, for example, azo compounds, such as azodicarbonamide (ADCA), 4,4′-oxybis(benzenesulfonyl hydrazide), 1,1′-azobis(1-acetoxy-1-phenylethane), dimethyl-2,2′-azobisbutyrate, dimethyl-2,2′-azobisisobutyrate, 2,2′-azobis(2,4,4-trimethylpentane), 1,1′-azobis(cyclohexane-1-carbonitrile), and 2,2′-azobis[N-(2-carboxyethyl)-2-methyl-propionamidine]; nitroso compounds, such as N,N′-dinitrosopentamethylenetetramine (DPT); hydrazine derivatives, such as 4,4′-oxybis(benzenesulfonyl hydrazide) and diphenylsulfone-3,3′-disulfonyl hydrazide; semicarbazide compounds, such as p-toluenesulfonyl semicarbazide; and trihydrazinotriazine, and inorganic thermal-decomposition-type foaming materials, for example, bicarbonates, such as sodium hydrogen carbonate and ammonium hydrogen carbonate, carbonates, such as sodium carbonate and ammonium carbonate; nitrites, such as ammonium nitrite, and hydrogen compounds.

Only one type of or a plurality of types of the microcapsule-type foaming materials and chemical foaming materials may be used.

The foaming start temperature of the foaming material can be 80° C. or higher and 100° C. or lower. When the record medium is produced, in general, after a coating liquid containing the foaming material is applied to the substrate, the coating liquid is dried to form the foaming layer. When the foaming start temperature of the foaming material is lower than 80° C., since the temperature during drying of the coating liquid has to be set at a temperature lower than the foaming start temperature, the productivity of the record medium may slightly deteriorate. On the other hand, when the foaming start temperature of the foaming material is higher than 100° C., since the heating temperature during formation of a stereoscopic image is increased, excessive heat energy may be required.

The foaming layer 12 contains the binder resin 14 so as to enhance the adhesiveness to the substrate 11. The binder resin plays an important role in suppressing the foaming layer from peeling off the substrate when the foaming material in the foaming layer is foamed due to heat. There is no particular limitation regarding the binder resin, and a water-insoluble resin can be used. The binder resin containing a water-insoluble resin enables the adhesiveness between the foaming layer and the substrate to be suppressed from deteriorating due to the foaming control liquid since the binder resin is not readily dissolved by water in the foaming control liquid. Further, even when an aqueous ink containing water is applied to the record medium, the adhesiveness between the foaming layer and the substrate is suppressed from deteriorating, for the same reason. In this regard, the water-insoluble resin is a resin, 95% by mass or more of which is left when the resin is immersed in warm water at 80° C. for 2 hours. The water-insoluble resin can be at least one selected from the group consisting of acrylic resins and urethane resins. In particular, the water-insoluble resin can be selected from the group consisting of acrylic resins having no ester group and urethane resins having no ester group. In addition, the water-insoluble resin can be a non-water-absorbing resin. The content of the water-insoluble resin in the foaming layer can be 10% by mass or more and 95% by mass or less with reference to the total mass of the foaming layer. In this regard, the foaming layer may contain a water-soluble resin in addition to the water-insoluble resin within the bound of obtaining the advantages of the present disclosure. Further, the glass transition temperature Tg of the binder resin can be −10° C. or higher and 30° C. or lower. The glass transition temperature of the binder resin being within the above-described range enables foaming of the foaming material to be suppressed from being hindered by the binder resin.

The mass ratio of the foaming material to the binder resin can be foaming material:binder resin=5:95 to 90:10. The mass ratio of the foaming material to the binder resin being within the above-described range enables both the foamability of the foaming material and the bondability to the substrate due to the binder resin to be improved.

The foaming layer may further contain components such as a pigment, an antioxidant, a dye, and a surfactant.

### Surface Layer

In the record medium, a surface layer may be disposed on the foaming layer within the bound of not impairing the foamability of the foaming layer. In this regard, even when the record medium includes the surface layer, the thickness and the like of the surface layer can be adjusted so that the surface temperature of the record medium is substantially equal to the temperature of the foaming layer of the record medium.

### Method for Manufacturing Record Medium

To produce the record medium, initially, a coating layer is formed by applying a coating liquid for the foaming layer containing the foaming material and the binder resin to the surface of the substrate. Subsequently, the foaming layer is formed by drying the resulting coating layer to obtain the record medium. To apply the coating liquid for the foaming layer to the surface of the substrate, air knife coaters, die coaters, blade coaters, gate roll coaters, bar coaters, rod coaters, roll coaters, gravure coaters, curtain coaters, and the like known in the related art may be used. Examples of the method for drying the coating layer include a method in which hot air is blown. Drying conditions (temperature, amount of gas, time, and the like) may be appropriately set in accordance with the type of the substrate, the composition of the coating liquid, and the like. In this regard, the temperature during drying has to be lower than the foaming start temperature of the foaming material.

The foaming layer in an amount of 2 g/m² or more per one surface of the substrate can be formed. The foaming layer in an amount of 2 g/m² or more being disposed enables the foamability to be further improved. In this regard, the record medium provided with the foaming layer containing the foaming material in advance may be used.

Of the surfaces of the substrate, the surface opposite to the surface provided with the foaming layer may be provided with a back coat layer. The back coat layer may be the same layer as the foaming layer containing the foaming material or may be a layer other than the foaming layer. In this regard, an adhesive layer containing an adhesive resin such as an acrylic resin or an ink-receiving layer for fixing the coloring material may be formed.

### Foaming Control Liquid

A foaming control liquid is the foaming control liquid used in the above-described method for manufacturing a recorded matter. In this regard, the foaming control liquid is applied to the foaming-layer-side surface of the record medium. The foaming control liquid will be described below in detail.

### Foaming Control Component

The foaming control liquid contains a foaming control component for promoting or suppressing foaming of the foaming material. In the present disclosure, the foaming control component that promotes foaming of the foaming material is also referred to as a “foaming promotion component”, and the foaming control component that suppresses foaming of the foaming material is also referred to as a “foaming suppression component”.

### Foaming Promotion Component

The foaming promotion component is a component that decreases the foaming start temperature of the foaming material. When the foaming control liquid containing the foaming promotion component (foaming promotion liquid) is applied to the surface of the record medium by using a technique of ejection, coating, or the like based on an ink jet system, the foaming promotion liquid permeates the foaming layer, the foaming promotion component in the foaming promotion liquid acts upon the foaming material contained in the foaming layer to decrease the foaming start temperature of the foaming material. Consequently, when the record medium is heated thereafter, foaming of the foaming material contained in the foaming layer in the region provided with the foaming promotion liquid is promoted.

When the foaming material is the microcapsule-type foaming particle, the foaming promotion component is a component capable of softening a thermoplastic resin contained in the shell layer of the foaming particle. As a result, it is conjectured that the foaming start temperature of the foaming particle is able to be decreased.

It is sufficient that the foaming promotion component used when the foaming material is the microcapsule-type foaming particle is a component capable of softening a thermoplastic resin contained in the shell layer of the foaming particle, and the foaming promotion component may be appropriately selected and used in accordance with the type and the like of the thermoplastic resin. Specifically, examples of the foaming promotion component include 2-pyrrolidone, dimethylsulfoxide, N,N-dimethylformamide, and N-methyl-2-pyrrolidone. In this regard, the foaming promotion component can be a compound having no hydroxy group.

The absolute value of the difference between the solubility parameter (SP1) of the thermoplastic resin constituting the shell layer of the foaming particle (microcapsule) and the solubility parameter (SP2) of the foaming promotion component (|SP1−SP2|) can be 3.5 or less. The absolute value of the difference in the solubility parameter being within the above-described numerical range enables the foamability of the region provided with the foaming promotion liquid containing the foaming promotion component in the foaming layer to be further improved.

In addition, the absolute value of the difference between the Hansen solubility parameter (HSP1) of the thermoplastic resin constituting the shell layer of the foaming particle (microcapsule) and the Hansen solubility parameter (HSP2) of the foaming promotion component (|HSP1−HSP2|) can be 20 or less. The absolute value of the difference in the Hansen solubility parameter being within the above-described numerical range enables the foamability of the region provided with the foaming promotion liquid containing the foaming promotion component in the foaming layer to be further improved.

The solubility parameter (SP value) of each of the thermoplastic resin constituting the shell layer and the foaming promotion component is a value determined by calculation. In addition, the Hansen solubility parameter (HSP value) of each of the thermoplastic resin constituting the shell layer and the foaming promotion component is a measurement value measured and calculated by using a dynamic light scattering method.

When the foaming material is a chemical foaming material, the foaming promotion component is a component that chemically promotes a chemical reaction necessary for generating gas from the chemical foaming material.

It is sufficient that the foaming promotion component used when the foaming material is the chemical foaming material is a component that chemically promotes a chemical reaction for generating gas from the chemical foaming material, and the foaming promotion component may be appropriately selected and used in accordance with the type of the chemical foaming material. Specifically, examples of the foaming promotion component include urea compounds such as urea and zinc compounds.

The boiling point of the foaming promotion component can be higher than the surface temperature T1 of the record medium heated in the first heating step. When the boiling point of the foaming promotion component is higher than the surface temperature T1, the foaming promotion component is not readily vaporized even when the record medium is heated in the first heating step and contributes to promotion of foaming of the foaming material. In addition, the boiling point of the foaming promotion component can be higher than the surface temperature T2 of the record medium heated in the second heating step.

The content of the foaming promotion component can be 20% by mass or more and 90% by mass or less with reference to the total mass of the foaming promotion liquid. The content of the foaming promotion component being within the above-described range enables the foamability of the foaming material to be improved.

### Foaming Suppression Component

The foaming suppression component is a component that increases the foaming start temperature of the foaming material or that inhibits the foaming material from foaming. When the foaming control liquid (foaming suppression liquid) containing the foaming suppression component is applied to the surface of the record medium by using a technique of ejection, coating, or the like based on an ink jet system, the foaming suppression liquid permeates the foaming layer, the foaming suppression component in the foaming suppression liquid acts upon the foaming material contained in the foaming layer so as to increase the foaming start temperature of the foaming material or inhibit the foaming material from foaming. Consequently, even when the record medium is heated thereafter, the foaming material contained in the foaming layer in the region provided with the foaming suppression liquid is suppressed from foaming.

When the foaming material is the microcapsule-type foaming particle, the foaming suppression component is a component capable of excessively softening a thermoplastic resin contained in the shell layer of the foaming particle. As a result, it is conjectured that, when the foaming suppression component acts upon the foaming particle or when the foaming particle is expanded due to heating after the foaming suppression component acts upon the foaming particle, a hole is formed in the shell layer of the foaming particle to inhibit the foaming particle from foaming.

It is sufficient that the foaming suppression component used when the foaming material is the microcapsule-type foaming particle is a component capable of excessively softening a thermoplastic resin contained in the shell layer of the foaming particle, and the foaming suppression component may be appropriately selected and used in accordance with the type and the like of the thermoplastic resin. As the component capable of excessively softening a thermoplastic resin contained in the shell layer, the same component as the foaming promotion component may be used. In this regard, in such an instance, the concentration of the foaming suppression component in the foaming suppression liquid can be increased. Specifically, the content of the foaming promotion component is preferably more than 90% by mass and 100% by mass or less and more preferably 95% by mass or more and 100% by mass or less with reference to the total mass of the foaming suppression liquid.

The absolute value of the difference between the solubility parameter (SP1) of the thermoplastic resin constituting the shell layer of the foaming particle (microcapsule) and the solubility parameter (SP2) of the foaming suppression component (|SP1−SP2|) can be 3.5 or less. The absolute value of the difference in the solubility parameter being within the above-described numerical range enables the foamability of the region provided with the foaming suppression liquid containing the foaming suppression component in the foaming layer to further deteriorate.

In addition, the absolute value of the difference between the Hansen solubility parameter (HSP1) of the thermoplastic resin constituting the shell layer of the foaming particle (microcapsule) and the Hansen solubility parameter (HSP2) of the foaming suppression component (|HSP1−HSP2|) can be 20 or less. The absolute value of the difference in the Hansen solubility parameter being within the above-described numerical range enables the foamability of the region provided with the foaming suppression liquid containing the foaming suppression component in the foaming layer to further deteriorate.

The solubility parameter (SP value) of each of the thermoplastic resin constituting the shell layer and the foaming suppression component is a value determined by calculation. In addition, the Hansen solubility parameter (HSP value) of each of the thermoplastic resin constituting the shell layer and the foaming suppression component is a measurement value measured and calculated by using a dynamic light scattering method.

When the foaming material is a chemical foaming material, the foaming suppression component is a component that chemically suppresses a chemical reaction necessary for generating gas from the chemical foaming material from occurring.

It is sufficient that the foaming suppression component used when the foaming material is the chemical foaming material is a component for chemically suppressing a chemical reaction to generate gas from the chemical foaming material, and the foaming suppression component may be appropriately selected and used in accordance with the type of the chemical foaming material. Specifically, examples of the foaming suppression component include benzotriazole-based compounds, such as 1,2,3-benzotriazole, 1-[N,N-bis(2-ethylhexyl)aminomethyl]benzotriazole, 1-[N,N-bis(2-ethylhexyl)aminomethyl]methylbenzotriazole, and 2,2′-[[(methyl-1H-benzotriazol-1-yl)methyl]imino]bisethanol.

The boiling point of the foaming suppression component can be higher than the surface temperature T1 of the record medium heated in the first heating step. When the boiling point of the foaming suppression component is higher than the surface temperature T1, the foaming suppression component is not readily vaporized even when the foaming layer is heated in the first heating step and contributes to suppression of foaming of the foaming material. In addition, the boiling point of the foaming suppression component can be higher than the surface temperature T2 of the record medium heated in the second heating step.

When the foaming suppression component is other than a component capable of excessively softening the thermoplastic resin contained in the shell layer, the content of the foaming suppression component can be 10% by mass or more and 70% by mass or less with reference to the total mass of the foaming suppression liquid.

### Other Components

When the foaming control component is a liquid at normal temperature (25° C.), the foaming control component itself may be used as the foaming control liquid. In this regard, the foaming control liquid may further contain components other than the foaming control component (other components). For example, to improve the ejection stability of the foaming control liquid, a liquid component such as a solvent can further be contained. Regarding the solvent, water and various water-soluble organic solvents may be used. Regarding water, deionized water (ion-exchanged water) can be used. Examples of the water-soluble organic solvent include alcohols, glycols, glycol ethers, and nitrogen-containing compounds.

Regarding the other components other than the liquid component, water-soluble organic compounds, such as urea or derivatives thereof, trimethylolpropane, and trimethylolethane, which are solid at a temperature of 25° C. may be used. Further, as the situation demands, various additives, such as pH adjusters, debubbling agents, rust inhibitors, preservatives, fungicides, antioxidants, reducing inhibitors, and chelating agents, may be contained in the foaming control liquid.

### Manufacturing Apparatus of Recorded Matter Having Stereoscopic Image

A manufacturing apparatus of a recorded matter having a stereoscopic image according to the present disclosure includes a first heating unit configured to heat a record medium including a substrate and a foaming layer that is disposed on the substrate and that contains a foaming material to be foamed due to heat and a binder resin, a foaming control liquid application unit configured to apply a foaming control liquid to the surface of the record medium heated by the first heating unit, by an ink jet recording head, and a second heating unit configured to heat the record medium provided with the foaming control liquid to form a stereoscopic image. In this regard, a surface temperature T0 (° C.) of the record medium before being heated by the first heating unit, a surface temperature T1 (° C.) of the record medium after being heated by the first heating unit, and a foaming start temperature Tf (° C.) of the foaming material satisfy a relationship represented by Formula (1),

T0<T1<Tf (1).

An ink, the foaming control liquid, and the record medium used in the manufacturing apparatus of a recorded matter are akin to the ink, the foaming control liquid, and the record medium used in the above-described method for manufacturing a recorded matter. The manufacturing apparatus of a recorded matter according to the present disclosure is suitable for use in the above-described method for manufacturing a recorded matter.

The manufacturing apparatus of a recorded matter may include an ink storage portion configured to store the ink and an ink application unit configured to eject the ink from an ink jet recording head to record an image on the record medium. In addition, the manufacturing apparatus of a recorded matter may also include a foaming control liquid storage portion configured to store the foaming control liquid. Further, the manufacturing apparatus of a recorded matter may also include a conveyance unit configured to convey the record medium.

The manufacturing apparatus of a recorded matter according to the present embodiment will be described below in detail with reference to the drawings. The manufacturing apparatus of a recorded matter described below is an exemplification of the present embodiment, and the manufacturing apparatus of a recorded matter according to the present disclosure is not limited to the following description.

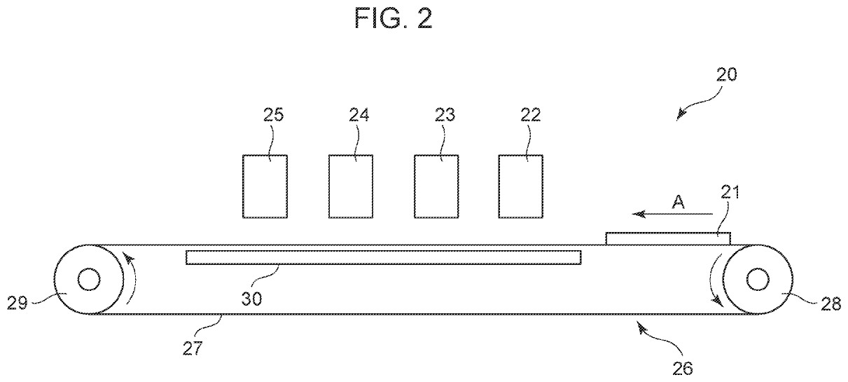

FIG. 2 is a schematic diagram illustrating a configuration of the manufacturing apparatus of a recorded matter having a stereoscopic image according to the present embodiment.

The manufacturing apparatus 20 of a recorded matter includes a first heating unit 22, a foaming control liquid application unit 23, a second heating unit 24, an ink application unit 25, and a conveyance unit 26.

The record medium 21 is conveyed by the conveyance unit 26 serving as a conveyance unit configured to convey the record medium in the direction of arrow A in FIG. 2. The conveyance unit 26 has a conveyance belt 27 serving as an endless belt, two rollers 28 and 29 configured to hold the conveyance belt 27. The record medium 21 is conveyed in the direction of arrow A due to the rollers 28 and 29 being driven to rotate. In addition, the conveyance unit 26 may have a platen 30 for regulating the displacement in the vertical direction of the conveyance belt 27. In this regard, the conveyance unit configured to convey the record medium may have a form including a feed roller for sending a sheet-like record medium from a roll of the record medium and a take-up roller for taking up the foamed record medium into a roll-like shape.

The first heating unit 22 is a heating unit configured to heat the record medium 21 before being provided with the foaming control liquid. Examples of the first heating unit 22 include dryers, ovens, heaters, and irons.

The foaming control liquid application unit 23 has an ink jet recording head for ejecting the foaming control liquid and ejects the foaming control liquid from the ink jet recording head to the record medium 21 conveyed by the conveyance unit 26.

The second heating unit 24 heats the record medium 21 provided with the foaming control liquid. It is sufficient that the second heating unit 24 is a heating unit capable of heating the surface of the record medium to a predetermined temperature. Examples of the second heating unit 24 include dryers, ovens, heaters, and irons. In this regard, FIG. 2 illustrates the configuration in which both the first heating unit and the second heating unit are arranged above the record medium (the front surface side of the record medium) and heat the record medium from above. However, the arrangement of the first heating unit and the second heating unit is not limited to this. For example, the first heating unit and the second heating unit may be arranged below the record medium (the back surface side of the record medium) and heat the record medium from below.

The ink application unit 25 has an ink jet recording head for ejecting an ink and applies the ink from the ink jet recording head to the record medium 21 foamed by the second heating unit 24. The ink application unit 25 may be arranged either upstream or downstream of the foaming control liquid application unit 23 or either upstream or downstream of the second heating unit 24 in the A-direction which is the conveyance direction of the record medium 21. In this regard, FIG. 2 illustrates the configuration in which the ink application unit 25 is arranged downstream of the foaming control liquid application unit 23 and downstream of the second heating unit 24 in the conveyance direction of the record medium 21 (A-direction).

Further, the manufacturing apparatus 20 of a recorded matter can include a cooling unit (not illustrated in the drawing) configured to cool the record medium 21 downstream of the second heating unit 24 in the A-direction which is the conveyance direction of the record medium 21. There is no particular limitation regarding the cooling unit provided that the cooling unit Is capable of cooling the heated record medium 21, and a technique of air cooling, water cooling, or the like may be utilized. Of these, unheated gas can be blown from the viewpoint of safety and energy efficiency. In addition, the cooling efficiency is readily increased by utilizing a mechanism which is incorporated with a fan configured to eject gas to the record medium 21 and which performs blowing. In consideration of the conveyance speed of the record medium 21 and the environment temperature, the temperature of the cooling unit may be set so that the image of the record medium is made to be at a predetermined temperature. In this regard, to suppress tight winding from occurring when the record medium 21 is taken up into a roll-like shape and stored or to suppress collapse of the foamed portion due to compression from occurring when the record medium 21 is stacked and stored, the record medium 21 can be cooled to 30° C. or lower. Consequently, the foamed portion of the foaming layer of the record medium is hardened and the foamed portion is suppressed from being collapsed.

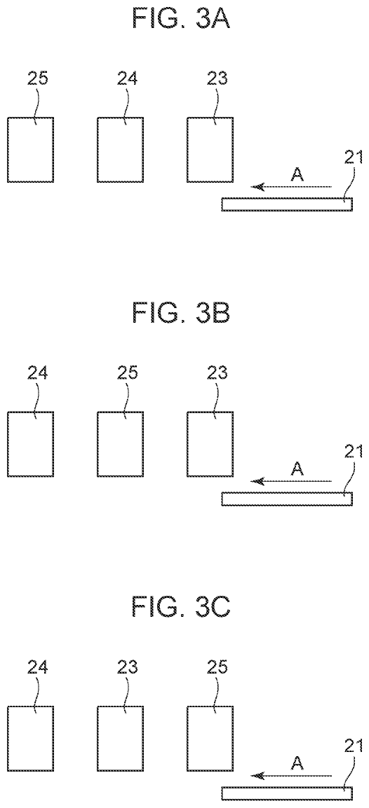

FIGS. 3A to 3C illustrate arrangements of the foaming control liquid application unit 23, the second heating unit 24, and the ink application unit 25 in the conveyance direction of the record medium 21.

FIG. 3A illustrates the configuration when the ink application unit 25 is arranged downstream of the foaming control liquid application unit 23 and downstream of the second heating unit 24 in the conveyance direction A of the record medium 21. FIG. 3B illustrates the configuration when the ink application unit 25 is arranged downstream of the foaming control liquid application unit 23 and upstream of the second heating unit 24 in the conveyance direction A of the record medium 21. FIG. 3C illustrates the configuration when the ink application unit 25 is arranged upstream of the foaming control liquid application unit 23 and upstream of the second heating unit 24 in the conveyance direction A of the record medium 21.

According to an aspect of the present disclosure, a method for manufacturing a recorded matter having a stereoscopic image, the method being capable of forming a stereoscopic image, in which the foamability is controlled and which has a sufficient foaming height, even when a recorded matter having a stereoscopic image is produced at a high speed and a manufacturing apparatus of a recorded matter having a stereoscopic image are provided.

### EXAMPLES

The present disclosure will be described below in detail with reference to the examples and the comparative examples. However, the invention is not limited to the examples below within the bound of not departing from the scope of the disclosure. The amount of the component expressed in “part” or “%” is on a mass basis, unless otherwise specified.

### Preparation of Foaming Particle

Regarding the foaming material, a foaming particle H1: “Matsumoto Microsphere HF-50” (produced by Matsumoto Yushi-Seiyaku Co., Ltd.), a foaming particle H2 “Expance1007-40” (produced by Japan Fillite Co., Ltd.), and a foaming particle H3 “ADVANCELL EMH204” (produced by Sekisui Chemical Co., Ltd.) were prepared. In this regard, a thermomechanical analyzer (TMA) (trade name “TMA 2940” produced by TA instruments) was used, and the foaming start temperatures of the foaming particles H1, H2, and H3 were measured in the following procedure. A sample in an amount of 25 μg was placed in an aluminum container having a diameter of 7 mm and a depth of 1 mm, and a state in which a load of 0.1 N was loaded from above was brought about. In such a state, heating was performed from 60° C. to 200° C. at a temperature increase rate of 5° C./min, and the displacement of a measurement terminal in the perpendicular direction was measured. Consequently, the displacement start temperature was assumed to be “foaming start temperature”.

The results are presented in Table 1. In this regard, all the foaming particles H1, H2, and H3 are microcapsule-type foaming particles.

TABLE 1

| Foaming | | Foaming start | |
|---|---|---|---|
| particle | Product name | temperature | |
| H1 | Matsumoto Microsphere HF-50 | 95° | C. |
| H2 | Expancel007-40 | 91° | C. |
| H3 | ADVANCELL EMH204 | 110° | C. |

### Production of Record Medium

### Record Medium 1

Regarding the substrate, a polypropylene synthetic paper roll (trade name “New YUPO FGS110” produced by YUPO CORPORATION) was prepared. A binder resin and the foaming particle H1 were added to ion-exchanged water where binder resin: foaming particle 1=100:50 (mass ratio), and a foaming layer coating liquid was obtained by performing sufficient agitation. Regarding the binder resin, an acrylic resin (acryl emulsion, trade name “Mowinyl 6950” produced by Japan Coating Resin Corporation) was used. After the substrate was coated with the resulting coating liquid in an amount of coating of 30 g/m², drying was performed so as to form the foaming layer, and taking up was performed by using a take-up unit so as to obtain Record medium 1.

### Record Medium 2

Record medium 2 was obtained by the method akin to that of Record medium 1 except that the foaming particle H1 was changed to the foaming particle H2.

### Record Medium 3

Record medium 3 was obtained by the method akin to that of Record medium 1 except that the binder resin was changed from Mowinyl 6950 to a urethane resin (trade name “SUPERFLEX 620” produced by Dai-ichi Kogyo Seiyaku Co., Ltd.).

### Record Medium 4

Record medium 4 was obtained by the method akin to that of Record medium 1 except that the foaming particle H1 was changed to the foaming particle H3.

### Adjustment of Foaming Control Liquid

### Foaming Control Liquid 1

Mixing of 35 parts of dimethylsulfoxide serving as a foaming control component, 0.5 parts of a nonionic surfactant (trade name “Acetylenol E60” produced by Kawaken Fine Chemicals Co., Ltd.) serving as a surfactant, and 64.5 parts of ion-exchanged water was performed. After sufficient agitation was performed, pressure-filtration with a filter having a pore size of 1.2 μm was performed so as to obtain Foaming control liquid 1.

### Foaming Control Liquid 2

Foaming control liquid 2 was obtained by the method akin to that of Foaming control liquid 1 except that dimethylsulfoxide was changed to N,N-dimethylformamide.

### Foaming Control Liquid 3

Foaming control liquid 3 was obtained by the method akin to that of Foaming control liquid 1 except that dimethylsulfoxide was changed to N-methyl-2-pyrrolidone.

### Foaming Control Liquid 4

Foaming control liquid 4 was obtained by the method akin to that of Foaming control liquid 1 except that dimethylsulfoxide was changed to 2-pyrrolidone.

### Foaming Control Liquid 5

Foaming control liquid 5 was obtained by the method akin to that of Foaming control liquid 1 except that the amount of dimethylsulfoxide added was changed to 95 parts and the amount of the ion-exchanged water added was changed to 4.5 parts.

In this regard, each of Foaming control liquids 1 to 4 was a foaming promotion liquid for promoting foaming of the microcapsule-type foaming particle. Foaming control liquid 5 was a foaming suppression liquid for suppressing the microcapsule-type foaming particle from foaming.

### Production of Recorded Matter

### Example 1

A recorded matter was produced by using a manufacturing apparatus of a recorded matter akin to that illustrated in FIG. 2 except that the heater serving as the first heating unit was mounted below the record medium and that the cooling unit is not illustrated in the drawing. In this regard, the surface temperature T0 of the record medium before being heated by the first heating unit was room temperature (25° C.). Initially, the record medium was heated by the first heating unit. Subsequently, after it was ascertained by an IR sensor (infrared sensor) that the surface temperature T1 of the record medium reached 35° C., Foaming control liquid 1 in an amount of 21 ng with respect to a pixel count of 600 dpi×600 dpi was applied to the foaming layer of Record medium 1 by using a foaming promotion liquid application unit having an ink jet recording head. Five seconds after application of the Foaming control liquid 1 to Record medium 1, the Record medium 1 provided with Foaming control liquid 1 was heated for 10 sec with hot air by the second heating unit so that the surface temperature T2 of the record medium reached 88° C. Further, the record medium heated by the second heating unit was cooled by the cooling unit having a blowing mechanism until the surface temperature of the record medium reached room temperature (25° C.) so as to obtain Recorded matter 1.

### Examples 2 to 9 and Comparative Examples 1 and 2

Recorded matters 2 to 9, 11, and 12 were obtained in the manner akin to that of Example 1 except that the record medium, the foaming control liquid, the surface temperature T1 of the record medium, the time from application of the foaming control liquid until start of heating by the second heating unit, and the surface temperature T2 of the record medium were changed as presented in Table 2.

### Example 10

Recorded matter 10 was obtained in the manner akin to that of Example 1 except that cooling of the record medium by the cooling unit was not performed.

### Comparative Example 3

Recorded matter 13 was obtained by the method akin to that of Example 1 except that heating by the first heating unit was not performed.

TABLE 2

| | | | | Time from | | | |
|---|---|---|---|---|---|---|---|
| | | | | application | | | |
| | | | | of foaming | | | |
| | | | | control liquid | Surface | Surface | |
| | | | | until heating | temperature | temperature | Foaming |
| | | | | by second | of record | of record | start |
| | | Foaming | Recorded | heating unit | medium T1 | medium T2 | temperature |
| | Record medium | control liquid | matter | (sec) | (° C.) | (° C.) | (° C.) |
| Example 1 | Record | Foaming | Recorded | 5 | 35 | 88 | 90 |
| | medium 1 | control liquid 1 | matter 1 | | | | |
| Example 2 | Record | Foaming | Recorded | 5 | 35 | 88 | 91 |
| | medium 2 | control liquid 1 | matter 2 | | | | |
| Example 3 | Record | Foaming | Recorded | 5 | 35 | 88 | 90 |
| | medium 1 | control liquid 2 | matter 3 | | | | |
| Example 4 | Record | Foaming | Recorded | 5 | 35 | 88 | 90 |
| | medium 1 | control liquid 3 | matter 4 | | | | |
| Example 5 | Record | Foaming | Recorded | 5 | 35 | 88 | 90 |
| | medium 1 | control liquid 4 | matter 5 | | | | |
| Example 6 | Record | Foaming | Recorded | 5 | 35 | 88 | 90 |
| | medium 3 | control liquid 1 | matter 6 | | | | |
| Example 7 | Record | Foaming | Recorded | 5 | 35 | 95 | 90 |
| | medium 1 | control liquid 5 | matter 7 | | | | |
| Example 8 | Record | Foaming | Recorded | 5 | 35 | 105 | 110 |
| | medium 4 | control liquid 1 | matter 8 | | | | |
| Example 9 | Record | Foaming | Recorded | 5 | 35 | 95 | 90 |
| | medium 1 | control liquid 1 | matter 9 | | | | |
| Example 10 | Record | Foaming | Recorded | 5 | 35 | 88 | 90 |
| | medium 1 | control liquid 1 | matter 10 | | | | |
| Comparative | Record | Foaming | Recorded | 5 | 35 | 88 | 90 |
| example 1 | medium 1 | control liquid 1 | matter 11 | | | | |
| Comparative | Record | Foaming | Recorded | 5 | 92 | 88 | 90 |
| example 2 | medium 1 | control liquid 1 | matter 12 | | | | |
| Comparative | Record | Foaming | Recorded | 5 | — | 88 | 90 |
| example 3 | medium 1 | control liquid 1 | matter 13 | | | | |

### Evaluation

A digital micrometer (trade name “M-30” produced by Sony Corporation) was used, and the height of a foamed portion of each of a portion printed with the foaming control liquid and an unprinted portion of the resulting recorded matter was measured. “Foaming height” indicates an absolute value of a difference in the foaming height between the printed portion and the unprinted portion. The results are presented in Table 3.
AA: Foaming height was 280 μm or more
A: Foaming height was 250 μm or more and 280 μm or less
B: Foaming height was 210 μm or more and 250 μm or less
C: Foaming height was less than 210 μm

TABLE 3

| | | Foaming height |
|---|---|---|
| Example 1 | Recorded matter 1 | AA |
| Example 2 | Recorded matter 2 | A |
| Example 3 | Recorded matter 3 | A |
| Example 4 | Recorded matter 4 | A |
| Example 5 | Recorded matter 5 | A |
| Example 6 | Recorded matter 6 | B |
| Example 7 | Recorded matter 7 | B |
| Example 8 | Recorded matter 8 | B |
| Example 9 | Recorded matter 9 | B |
| Example 10 | Recorded matter 10 | B |
| Comparative example 1 | Recorded matter 11 | C |
| Comparative example 2 | Recorded matter 12 | C |
| Comparative example 3 | Recorded matter 13 | C |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-107061, filed Jul. 1, 2022 and No. 2023-094576 filed Jun. 8, 2023, which are hereby incorporated by reference herein in their entirety.

What is claimed is:

1. A method for manufacturing a recorded matter having a stereoscopic image comprising:
a first heating step of heating a record medium including a substrate and a foaming layer that is disposed on the substrate and that contains a foaming material to be foamed due to heat and a binder resin;
a foaming control liquid application step of applying a foaming control liquid for controlling foaming of the foaming material to the surface of the record medium heated in the first heating step by an ink jet recording head; and
a second heating step of heating the record medium provided with the foaming control liquid to form a stereoscopic image,
wherein a surface temperature T0 (° C.) of the record medium before being heated in the first heating step, a surface temperature T1 (° C.) of the record medium after being heated in the first heating step, and a foaming start temperature Tf (° C.) of the foaming material satisfy a relationship represented by Formula (1):
T0<T1<Tf (1).

2. The method for manufacturing a recorded matter having a stereoscopic image according to claim 1,
wherein T1 and a surface temperature T2 (° C.) of the record medium after being heated in the second heating step satisfy Formula (2):
T1<T2 (2).

3. The method for manufacturing a recorded matter having a stereoscopic image according to claim 1,
wherein T1 is higher than a glass transition temperature Tg of the binder resin.

4. The method for manufacturing a recorded matter having a stereoscopic image according to claim 1, further comprising, after the second heating step, a cooling step of cooling the heated record medium.

5. The method for manufacturing a recorded matter having a stereoscopic image according to claim 1,
wherein the foaming material is a foaming particle including a shell layer containing a thermoplastic resin and a volatile material sealed in the shell layer.

6. The method for manufacturing a recorded matter having a stereoscopic image according to claim 5,
wherein the thermoplastic resin contains a polyacrylonitrile copolymer.

7. The method for manufacturing a recorded matter having a stereoscopic image according to claim 5,
wherein the volatile material is isobutane.

8. The method for manufacturing a recorded matter having a stereoscopic image according to claim 1,
wherein the foaming control liquid is a foaming promotion liquid containing a foaming promotion component for decreasing a foaming start temperature of the foaming material.

9. The method for manufacturing a recorded matter having a stereoscopic image according to claim 8,
wherein the foaming promotion component is at least one member selected from the group consisting of 2-pyrrolidone, dimethylsulfoxide, N,N-dimethylformamide, and N-methyl-2-pyrrolidone.

10. The method for manufacturing a recorded matter having a stereoscopic image according to claim 1,
wherein Tf is higher than a foaming start temperature Tf′ of the foaming material acted upon by the foaming promotion component.

11. A manufacturing apparatus of a recorded matter having a stereoscopic image comprising:
a first heating unit configured to heat a record medium including a substrate and a foaming layer that is disposed on the substrate and that contains a foaming material to be foamed due to heat and a binder resin;
a foaming control liquid application unit configured to apply a foaming control liquid for controlling foaming of the foaming material to the surface of the record medium heated by the first heating unit, by an ink jet recording head; and
a second heating unit configured to heat the record medium provided with the foaming control liquid to form a stereoscopic image,
wherein a surface temperature T0 (° C.) of the record medium before being heated by the first heating unit, a surface temperature T1 (° C.) of the record medium after being heated by the first heating unit, and a foaming start temperature Tf (° C.) of the foaming material satisfy a relationship represented by Formula (1):
T0<T1<Tf (1).
